(19) United States
(12) Patent Application Publication
(10) Pub. No.: US 2015/0048218 A1
(43) Pub. Date: Feb. 19, 2015

(54) SUPPORTING DEVICE FOR CABLES AND METHOD FOR USING THE SAME

(71) Applicant: National Oilwell Varco Norway AS, Kristiansand S (NO)

(72) Inventor: Cay Reiersdal, Kristiansand (NO)

(73) Assignee: National Oilwell Varco Norway AS, Kristiansand S (NO)

(21) Appl. No.: 14/387,188

(22) PCT Filed: Mar. 21, 2013
(86) PCT No.: PCT/NO2013/050058

§ 371 Date: Sep. 22, 2014

Related U.S. Application Data
(60) Provisional application No. 61/614,068, filed on Mar. 22, 2012.

(51) Int. Cl. F16L 3/01; F16L 3/12; H02G 11/00; F16L 57/06

(52) U.S. Cl. CPC F16L 3/01; F16L 57/06; F16L 3/12; H02G 11/006
USPC 248/51; 29/525.01

(57) ABSTRACT

There is described a supporting device for one or more cables, where at least one end of each cable is connected to moving machinery, wherein the supporting device comprises two or more substantially parallel, spaced apart, flexible side bands, a plurality of interconnectors, each interconnector connecting two or more side bands, wherein the supporting device is provided with fastening means for fastening cables to at least some of the interconnectors. There is also described a method for supporting one or more cables.

### CROSS REFERENCE TO RELATED APPLICATIONS

This application is a 35 U.S.C. §371 national stage application of PCT/NO2013/050058 filed Mar. 21, 2013, which claims the benefit of U.S. Provisional Application No. 61/614,068 filed Mar. 22, 2012, incorporated herein by reference in their entirety for all purposes.

### BACKGROUND

The present disclosure relates to a supporting device for cables. More specifically, the disclosure relates to a device for supporting cables, hoses, tubes, etc. connected to moving machinery, e.g., to a moving top drive on a drilling rig. However, the disclosure is not limited to drilling rigs.

Cables, hoses, tubes, connectors, etc., hereinafter just named cables, connected to moving machinery tend to wear out because the weight of the cables is supported entirely by the ends of the cables. As at least one cable end is connected to moving machinery, the weight of the cable is changingly supported by the opposing ends of the cable. Known solutions for supporting such cables, for example so-called drag chains, consist of a number of chained links where various cables are loosely guided in between the links. Due to the risk of falling objects, and because parts of the drag chains might work loose, it is not desirable to use drag chains on drilling rigs. Furthermore, drag chains are only capable of stepwise curvature, and thus not adapted to closely follow the curvature of the various cables as the machinery is moving. The latter is likely to cause friction and stress on the cables, and thus significantly shorten the lifetime of the cables. On drilling rigs, to avoid or at least reduce the risk of falling objects, it is common to embed different cables into a common cable housing filled with a potting material. The potting material is expensive and the cable housing is rather tedious and expensive to install. The cables in the cable housing have to be replaced all at the same time, and there has been a challenge with power cables not getting sufficient cooling in the potting.

U.S. Pat. No. 6,708,480 B1 discloses a strand for a line guide arrangement, where the strand comprises a plurality of fiber-reinforced flexibly joined segments. Cables can be loosely carried in hollow sections in the strands or in struts connecting two separate strands.

### BRIEF SUMMARY OF THE DISCLOSURE

In a first aspect the disclosure relates to a supporting device for one or more cables, where at least one end of each cable is connected to moving machinery, wherein the supporting device comprises: two or more substantially parallel, spaced apart, flexible side bands, and a plurality of interconnectors, each interconnector connecting two or more side bands, wherein the supporting device is provided with fastening means for fastening cables to at least some of the interconnectors.

The cables that are fastened to the interconnectors of the supporting device may be electric, fibre optic, hydraulic, and pneumatic cables, hoses, tubes etc. By fastening the cables to the interconnectors, the weight of the cables can be carried substantially by the supporting device. By fastening the cables to a plurality of interconnectors distributed along the length of the side bands, the weight of the various cables can be distributed more or less evenly along the length of the supporting device, in comparison to some of the prior art mentioned above, where the weight is supported entirely at the cables' ends. Furthermore, having cables attached to the interconnectors is intended to help prevent the cables from becoming misaligned. The latter has especially been a challenge when using cables with different stretch characteristics. A supporting device according to the present disclosure will be easily accessible for maintenance and for adding or replacing cables, in comparison to the above-mentioned cable housings filled with potting material. The fact that the weight of the various cables is carried substantially by the supporting device is also intended to enable utilization of heavier cables, such as twisted three-leader power cables, which are typically too heavy to be supported at its ends only. The phrase “moving machinery,” as it is used herein, will also comprise passively moving devices, such as two vessels drifting relative to each other.

In one embodiment, the side bands may comprise a polymer, such as rubber. Rubber will make the side bands flexible, robust, and sustainable to pollution. The side bands may be made entirely from rubber, except for potential reinforcement means, or the side bands may contain rubber, e.g., being covered by rubber, while also comprising other materials.

In one embodiment, the interconnectors may comprise a vulcanized polymer, such as rubber. The interconnectors may consist essentially of the vulcanized polymer, or the interconnectors may be covered by the vulcanized polymer.

The interconnectors may be vulcanized to the side bands. This implies that the interconnectors may be connected to the side bands without the use of additional attachment means such as screws, bolts, etc. that might work loose, and thus constitute a falling object. Alternatively, rubber may be moulded around additional attachment means used to connect the interconnectors to the side bands. In one embodiment the whole supporting device may be moulded in rubber.

In one embodiment, the side bands of the supporting device may have a higher tensile strength than the cables that the supporting device is adapted to support. The higher tensile strength of the side bands implies that forces acting to stretch the supporting device will be taken up substantially by the side bands and not by the cables, thus reducing wear of the cables.

The side bands and the cables may be connected to the same side, hereinafter named “the upper surface,” of the interconnectors. The cross-sectional center of a cable and the cross-sectional center of a side band, both in a plane transverse to the length of the cables and the side bands, may then be at the same distance from the upper surface of the interconnector, whereby the side bands and the cables may obtain substantially the same radius of curvature as the machinery is moving. This may significantly reduce wear of the cables as stretching of the cables will be reduced.

In one embodiment, interconnectors can be provided with heightening means for raising cables above the upper surface of the interconnectors. The cross-sectional center of a smaller cable and the cross-sectional center of a side band, both in a plane transverse to the length of the cables and the side bands, can then also be at the same distance from the upper surface of the interconnector, whereby the side bands and cables of smaller diameter may also obtain substantially the same radius of curvature. The heightening means may be a part of the interconnectors as produced, or the heightening means may subsequently be connected to the interconnectors, e.g., by means of vulcanization. In an alternative embodiment, where the distance from the upper surface of an interconnector to the cross-sectional center of a cable is larger than the distance the upper surface of the interconnector to the cross-sectional center of the side bands, both in a plane transverse to the length of the cables and the side bands, the interconnector may be formed with a recess for the cable to compensate the offset in distance.

In one embodiment, the sidebands may be reinforced by means of one or more of the following materials: steel, aluminium, and a composite, such as a glass or carbon reinforced polymer. The reinforcing material(s) may be embedded in a side band as one or more wires running along substantially the whole length of the side band.

The means for fastening cables to the interconnectors may comprise one or more of the following means: rubber bands, clamping blocks, tie raps; and lugs.

In one embodiment, the interconnectors may be substantially evenly distributed along the length of the side bands. The weight of the cables may thus be substantially evenly distributed along the length of the supporting device. The interconnectors may be substantially perpendicular to the length of the sidebands, giving the supporting device a ladder-like appearance. The distance between each interconnector along the side bands may vary between different supporting devices according to the disclosure. A relatively small distance between consecutive interconnectors will enable distribution of the weight of the cables over many fastening points. However, a small distance between consecutive interconnectors needs a very good match in radius of curvature between the side bands and the cables to avoid stretching of the cables. A larger distance between consecutive interconnectors implies that the weight of the cables will be distributed between a smaller number of fastening points, but at the same time the larger distance between the interconnectors reduces the need to match the radius of curvature between the cables and the side bands. The optimal design of a supporting device according to the disclosure will thus potentially vary for different intended uses.

In one embodiment, the interconnectors may be substantially non-flexible, meaning that the interconnectors are sufficiently rigid for the distance between the side bands to be substantially constant. The interconnectors will provide stability against sideways movement, which may be caused by wind, heave etc. It has been a problem that loosely hanging cables swing out and get hooked up in moving machinery.

In a second aspect, the disclosure relates to a cable for a top drive, a lift, or a travelling crane, the cable being supported by a supporting device according to the above description.

According to the disclosure, at least one end of each cable is connected to moving machinery. This implies that the other end of each cable may be connected to other moving machinery or to a stationary connection point. The machinery may be adapted to move vertically and/or horizontally.

In a third aspect, the disclosure relates to a method for supporting one or more cables, where at least one end of each cable is connected to moving machinery, the method comprising connecting two or more substantially parallel, spaced apart, flexible side bands by means of a plurality of interconnectors, and fastening said one or more cables to at least some of the interconnectors by using fastening means.

In one embodiment of the method, the step of connecting the two or more side bands to the interconnectors may include vulcanizing the interconnectors to the side bands. Certain characteristics thereof are described above.

The method may further comprise the step of covering the interconnectors by a layer of vulcanized rubber.

In one embodiment, the step of fastening the one or more cables to at least some of the interconnectors includes utilizing one or more of the following fastening means: tie raps, clamping blocks, lugs, and rubber bands.

### BRIEF DESCRIPTION OF THE DRAWINGS

Hereinafter, examples of non-limiting, exemplary embodiments are described and are depicted on the accompanying drawings, where:

FIG. 1 shows in a perspective view a supporting device according to a first embodiment of the disclosure;

FIG. 2 shows in a perspective view and in a larger scale than FIG. 1, a part of a supporting device according to the disclosure;

FIG. 3 shows a detailed view of part A from FIG. 2;

FIG. 4 shows a detailed view of part B from FIG. 2;

FIG. 5 shows in a cross-sectional view and in a larger scale the supporting device from FIG. 2;

FIG. 6 shows an enlarged view of part C from FIG. 5;

FIG. 7 shows in a perspective view a part of a supporting device according to a second embodiment of the disclosure;

FIG. 8 shows in a perspective view a part of a supporting device according to a third embodiment of the disclosure; and

FIG. 9 shows a detailed view of part D from FIG. 8.

In the following, the reference numeral 1 indicates a supporting device according to the disclosure. Similar reference numerals indicate similar or equivalent parts.

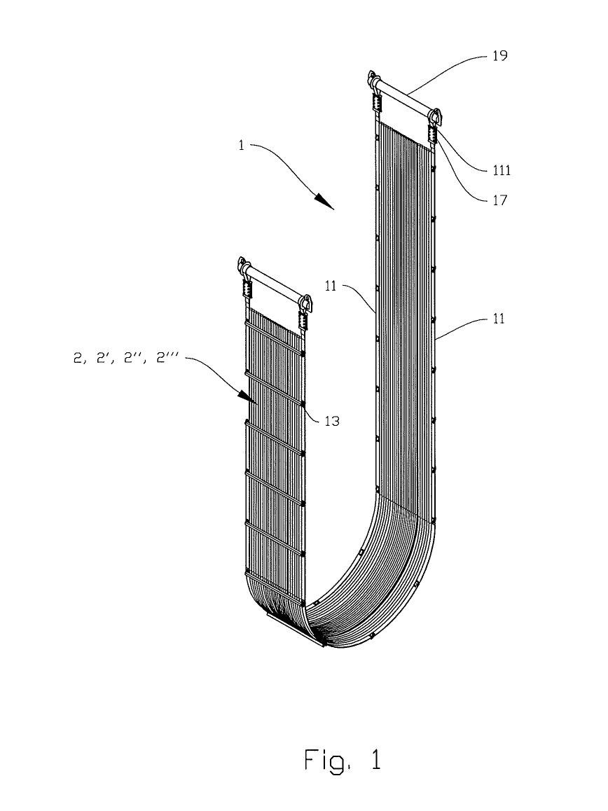

In FIG. 1, an isolated supporting device 1 according the disclosure is shown. In use, at least one end of the supporting device 1 will be connected to moving machinery. The shown supporting device 1 comprises two substantially parallel, spaced apart, reinforced, flexible side bands 11. The reinforcement means are not explicitly shown in the figures. The side bands 11 are connected by non-flexible interconnectors 13 substantially equally spaced along the length of the side bands 11. The ends of the sidebands 11 are provided with loops 111, which are connected to the side bands 11 with clamping means 17, the loops 111 being connected to cross bars 19. The supporting device 1 is supporting a plurality of different cables 2, 2′, 2″, 2″′ with different diameters. In the shown embodiment, the interconnectors 13 are screwed into the side bands 11. Subsequently the connection between the side bands 11 and the interconnectors 13 may be molded in a polymer, such as rubber, and preferably vulcanized. The optional molding and vulcanization is not shown on the figures.

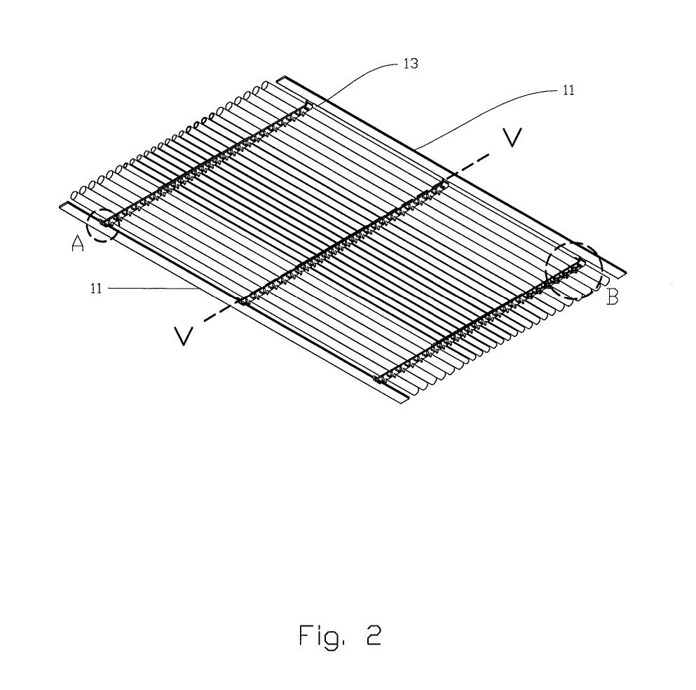

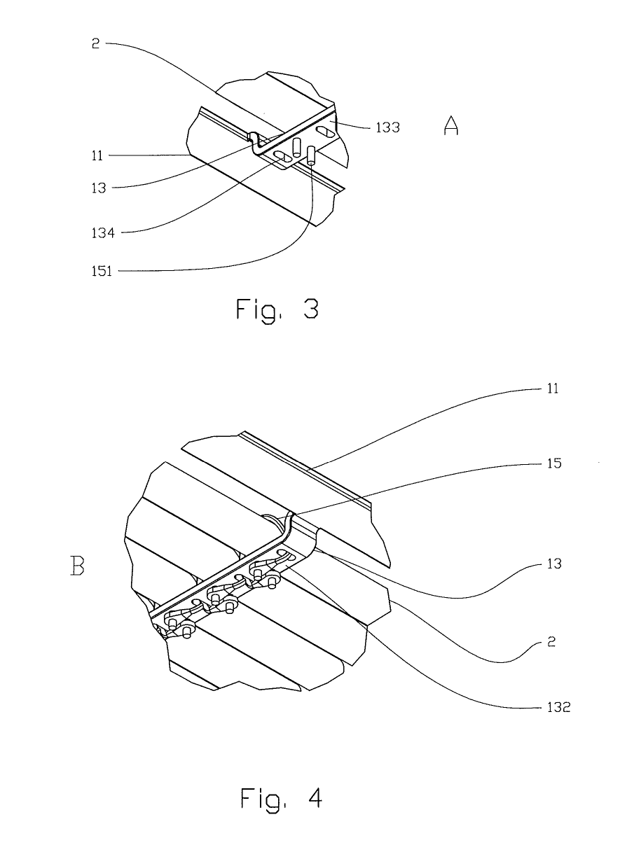

An enlarged view of a part of the supporting device 1 is shown in FIG. 2. Further enlarged views of parts A and B from FIG. 2 are shown in FIGS. 3 and 4, respectively. The cables 2, 2′, 2″, 2″′ are connected to at least some of the interconnectors 13 with fastening means 15 in the form of rubber bands. FIG. 3 shows a part of a cable 2 lying loosely on the interconnector 13, while FIG. 4 shows a part of a cable 2 being fastened to the interconnector 13 by a rubber band 15. The rubber band 15 is wrapped around the cable 2, through a hole 134 in the interconnector and fastened to a lower surface 132 of the interconnector 13, the lower surface 132 of the interconnector 13 being provided with pins 151 to which holes at the ends of the rubber bands 15 are complementary fitting.

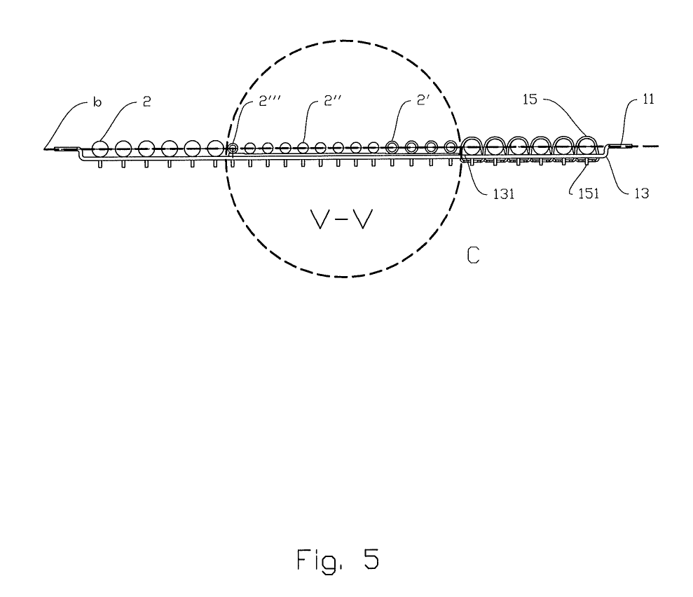

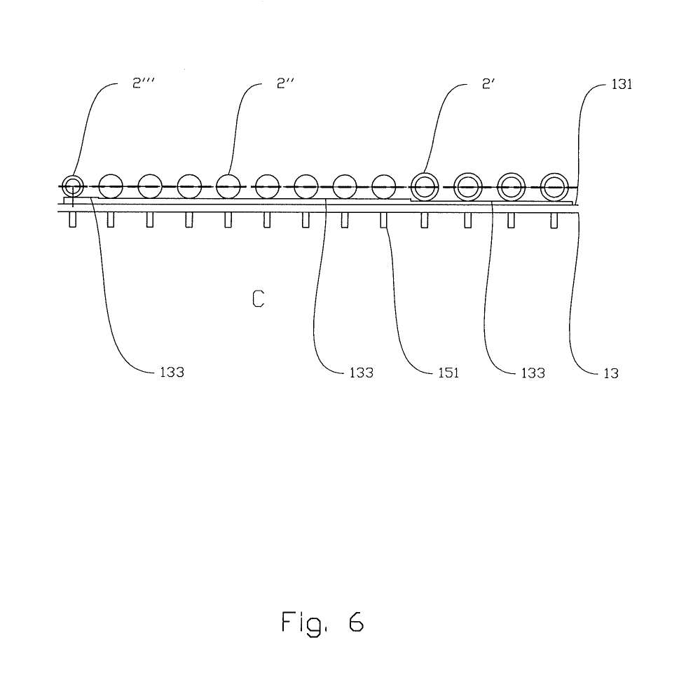

In FIGS. 5 and 6, a cross-sectional view of a supporting device 1 seen through the line V-V on FIG. 2 is shown. The interconnector 13 is vulcanized to the side bands without the use of additional connection means. In the shown embodiment, the supporting device is supporting cables 2, 2′, 2″, 2″′ of four different diameters. Some of the cables 2 are shown fastened to the interconnectors by means of rubber bands as described above. The interconnector 13 is shaped with a bend towards its connection to the side bands 11. Cables 2 with a large diameter may thus be placed directly on an upper surface 131 of the interconnector while obtaining substantially the same radius of curvature as the side bands 11 as the supporting device 1 is bent. To compensate for cables 2′, 2″, 2″′ of smaller diameters, the interconnector 13 is provided with heightening means 133 on its upper surface 131. The heightening means 133 raise the cables 2′, 2″, 2″′ of smaller diameters above the upper surface 131 of the interconnector 13 so that these cables 2′, 2″, 2″′ may also obtain substantially the same radius of curvature as the side bands 11 as the supporting device is bent. Heightening means 133 in the form of blocks are provided in three different heights with blocks 133 of increasing height corresponding to cables of reduced diameter. A natural bending axis a is shown in the figure where the height of the cross-sectional center of the side bands is coinciding with height of the cross-sectional center of the cables 2, 2′, 2″, 2″′. The side bands 11 and the cables 2, 2′, 2″, 2″′ with different diameters may thus obtain substantially the same radius of curvature. This will allow the cables 2, 2′, 2″, 2″′ to be fastened to the interconnectors 13 while still avoiding stretching of the cables 2,2′,2″,2′″.

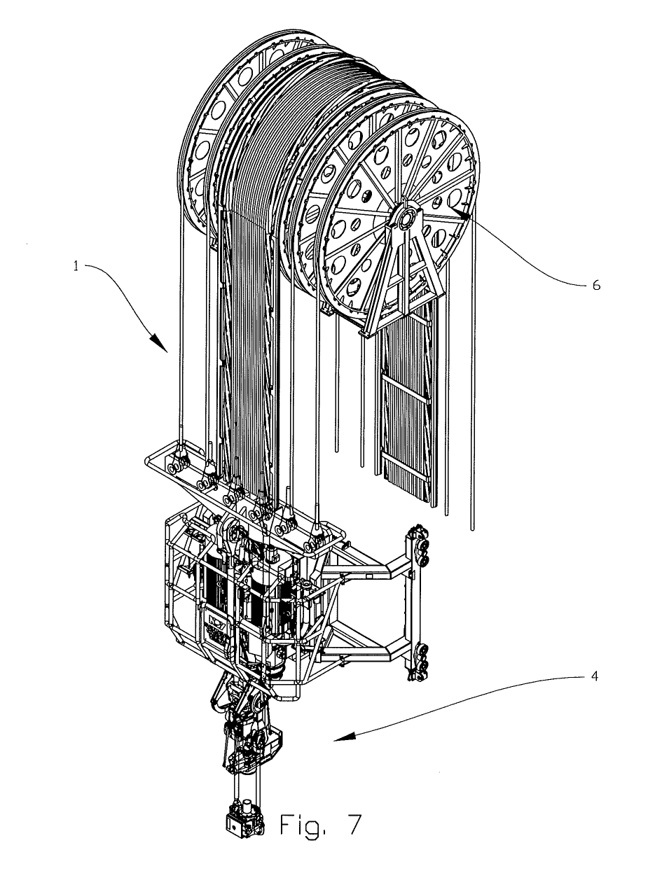

In FIG. 7, another embodiment of a part of a supporting device 1 according to the disclosure is shown. One end of the supporting device is connected to a top drive 4 on a drilling rig (not shown). The other end of the supporting device is connected to a derrick (not shown) via a sheave cluster 6. The supporting device 1 is gliding on the sheave cluster 6 as the top drive 4 is moving, thus further relieving the cables 2, 2′, 2″, 2″′ from the forces of gravity acting on them.

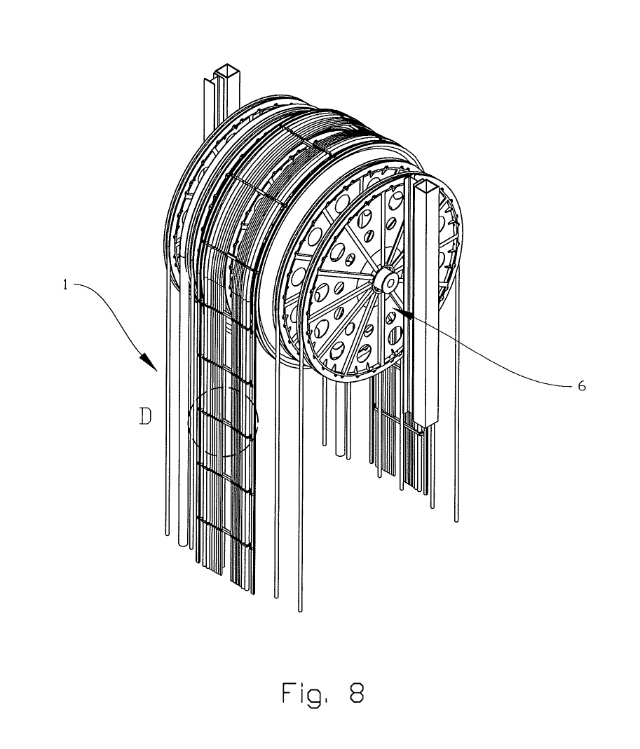

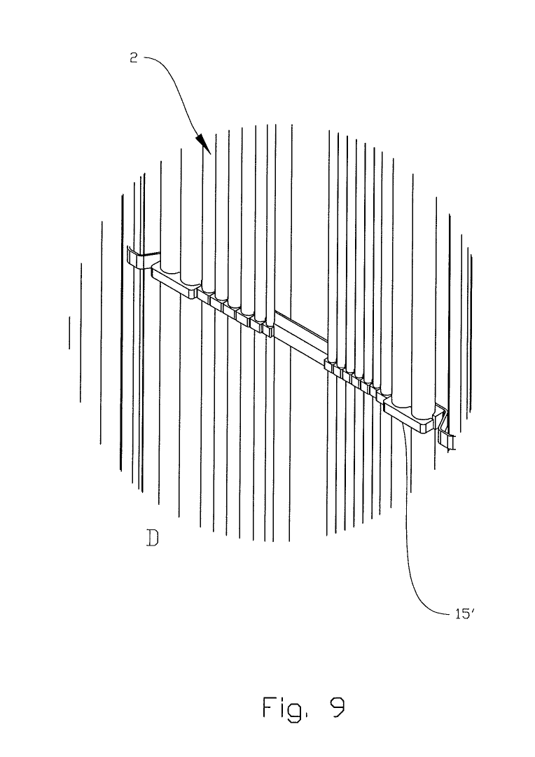

FIG. 8 shows another embodiment of a part of a supporting device 1 according to the disclosure. Neither ends of the supporting device 1 is shown in the figure. FIG. 9 shows an enlarged view of part D from FIG. 8. In the shown embodiment, the cables 2, 2′, 2″, 2″′ are fastened to the interconnectors by alterative fastening means 15′, here in the form of clamping blocks. Clamping blocks 15′ of different sizes are adapted to fasten the cables 2, 2′, 2″, 2″′ of different diameters to the interconnectors 13. The clamping blocks 15′ are designed as combined fastening means and heightening means, with functionality similar to the combination of the rubber bands 15 and the heightening blocks 133.

1. A supporting device for one or more cables, where at least one end of each cable is connected to moving machinery, wherein the supporting device comprises:
two or more substantially parallel, spaced apart, flexible side bands;
a plurality of interconnectors, each interconnector connecting two or more side bands, wherein the supporting device is provided with fastening means for fastening cables to at least some of the interconnectors.

2. The supporting device according to claim 1, wherein the side bands comprise a polymer, such as rubber.

3. The supporting device according to claim 1, wherein the interconnectors comprise a vulcanized polymer, such as vulcanized rubber.

4. The supporting device according to claim 3, wherein the interconnectors are connected to the side bands at least partially by means of vulcanization.

5. The supporting device according to claim 1, wherein the side bands have a higher tensile strength than the cables that the supporting device is adapted to support.

6. The supporting device according to claim 1, wherein the side bands and the cables are connected to the same side of the interconnectors, whereby the side bands and the cables may obtain substantially the same radius of curvature.

7. The supporting device according to claim 1, wherein the interconnectors are provided with heightening means for raising cables above the interconnector upper surface, whereby the side bands and cables of smaller diameter may also obtain substantially the same radius of curvature.

8. The supporting device according to claim 1, wherein the side bands are reinforced by means of one or more of the following materials:
steel,
aluminium, or
a composite, such as a glass or carbon reinforced polymer.

9. The supporting device according to claim 1, wherein the fastening means comprise one or more of the following means:
tie raps,
clamping blocks,
lugs, and
rubber bands.

10. The supporting device according to claim 1, wherein the interconnectors are substantially evenly distributed along the length of the two or more side bands.

11. The supporting device according to claim 1, wherein the Interconnectors are substantially non-flexible.

12. A top drive comprising a supporting device according to claim 1 and a cable being supported by the supporting device.

13. A lift comprising a supporting device according to claim 1 and a cable being supported by the supporting device.

14. A travelling crane comprising a supporting device according to claim 1 and a cable being supported by the supporting device.

15. A method for supporting one or more cables, where at least one end of each cable is connected to moving machinery, the method comprising:
connecting two or more substantially parallel, spaced apart, flexible side bands by means of a plurality of interconnectors; and
fastening said one or more cables to at least some of the interconnectors by using fastening means.

16. The method according to claim 15, wherein the step of connecting the two or more side bands to the interconnectors includes vulcanizing the interconnectors to the side bands.

17. The method according to claim 15, further comprising vulcanizing the interconnectors.

18. The method according to claim 15, wherein the step of fastening the one or more cables at least some of the interconnectors includes utilizing one or more of the following fastening means:
tie raps,
clamping blocks,
lugs, and
rubber bands.
